(19) United States
(12) Patent Application Publication
(10) Pub. No.: US 2008/0313167 A1
(43) Pub. Date: Dec. 18, 2008

(54) System And Method For Intelligently Indexing Internet Resources

(76) Inventor: Jim Anderson, White Plains, NY (US)

Correspondence Address: FISH & RICHARDSON P.C., P.O. BOX 1022, MINNEAPOLIS, MN, 55440-1022, US

(21) Appl. No.: 11/763,871

(22) Filed: Jun. 15, 2007

(51) Int. Cl. G06F 17/30

(52) U.S. Cl. 707/5; 707/E17.108

(57) ABSTRACT

The present invention is a system and method for building an intelligent index of Internet web pages. A populator retrieves a web page, divides words within the web page into categories, and determines a relevancy rating for the words in each category, the relevancy rating based on the number of appearances of the word in the corresponding category. The populator then weights each relevancy rating by a weighting factor corresponding to the category, and sums the weighted relevancy ratings to determine a web page relevancy rating for each unique word. The categories include a header, hidden words, non-sentences, repetitive words, non-nouns, and nouns. Each category is further subdivided into subcategories of commonly used words and uncommonly used words. A relevancy rating is determined for each subcategory.

### FIELD OF THE INVENTION

The present invention relates generally to the indexing and searching of databases. More specifically, the present invention relates to indexing the Internet in a way which allows users to efficiently search for information.

### BACKGROUND OF THE INVENTION

The Internet is an extremely valuable tool for researching and obtaining information. However, due to the increasing proliferation of information available over the Internet, it is becoming more difficult for Internet users to locate useful information. A number of search engines currently exist which help users find information on the Internet. With millions of new sites and an abundance of content being added to the Internet each day, existing search engines experience problems.

For example, if an Internet user is trying to find out information about the computing language Java, he or she may enter a search query such as “Java AND programming AND software” into a typical search engine. Unfortunately, existing search engines may return thousands of resulting links, or “hits.” Additionally, many of the Internet sites produced in the results might not be directly related to the search, for reasons described further below.

When search results are provided to the search engine user, the order in which the results are presented is important. The Internet user would like to have the most valuable and relevant links listed in front; (i.e., those links which will be of most use to him or her). The order in which results are provided is determined in various ways. Some search engines or web browsers allow advertisers, or other content providers to pay a fee in order to appear near the top of the list. The problem with this method is that a search engine user may not get the most sought after information or may see commercially motivated search results before seeing any other meaningful information.

Search engines can also rank the results in terms of relevancy ranking based upon sources of content that contain the most occurrences of the words being searched. Some search engines determine the relevancy of a web page based on the “header” of the web page. The header section of the HTML source of a web page contains text called meta-tags. Meta-tags are inserted into the web page by the web page designer. The Meta-tags specify a description and a set of keywords for the page. The problem with using these Meta-tags to form a search index is that web page designers sometimes load the header with erroneous meta-tags to “fool” search engines. Some web site owners attempt to pull unsuspecting customers to their web site and buy their products or view their content. For example, a web page selling automobiles might load the header with the word “Java” or “baseball” to lure anyone searching for these words.

Another method of providing misleading or erroneous search results used by web page owners to lure unsuspecting customers inserts “hidden” text into web pages. Hidden text is text that is embedded into the web page but is not visible to the Internet users. For example, hidden text font can be colored the same as the background, so the hidden text is not visible. The reason that web page owners insert hidden text into their web pages is again to fool search engines. For example, the automobile seller described above might stick the following hidden text in his web page: Java, baseball, dogs, cats, and dinosaurs. Anyone searching for one of these words would erroneously be taken to a web page selling automobiles.

These and other techniques designed to lure unsuspecting searchers to irrelevant web pages make it difficult for Internet users to find useful and relevant information efficiently using existing search engines. Some search engines have tried to address this problem by hiring people to individually review web site submissions and manually enter the content of the web page into an index. However, this is extremely labor intensive. Additionally, the proliferation of information on the Internet makes it increasingly difficult to locate sought after information. A need exists for a search engine that can find useful information on the Internet while filtering out the aforementioned techniques to fool search engines. A need also exists for an automatic index builder that can build an index of the Internet to determine the relevancy of each word on web pages, web sites, and other Internet resources to help searchers quickly find useful and relevant information for which they are searching.

### SUMMARY OF THE INVENTION

The present invention is directed to a system and method for building and indexing content found in a networked database, such as an index of Internet web pages. A populator retrieves a web page, divides words within the web page into categories, and determines a relevancy rating for the words in each category; the relevancy rating is based on the number of appearances of the word in the corresponding category. The populator then weights each relevancy rating by a weighting factor corresponding to the category, and sums the weighted relevancy ratings to determine a web page relevancy rating for each unique word. The categories include a header, hidden words, non-sentences, repetitive words, non-nouns, and nouns. Each category is further sub-divided into subcategories of commonly used words and uncommonly used words. A relevancy rating is determined for each subcategory.

### BRIEF DESCRIPTION OF THE DRAWINGS

FIG. 1 depicts a block diagram illustrating an implementation of the system of the present invention.

FIGS. 2A and 2B depict a flowchart illustrating an implementation of the method of the present invention.

FIG. 3 is a block diagram illustrating an implementation of a method of the present invention.

FIG. 4 depicts an exemplary commonly used words table.

FIG. 5 depicts a flowchart illustrating an implementation of a method of generating a living commonly used words table.

### DETAILED DESCRIPTION OF THE INVENTION

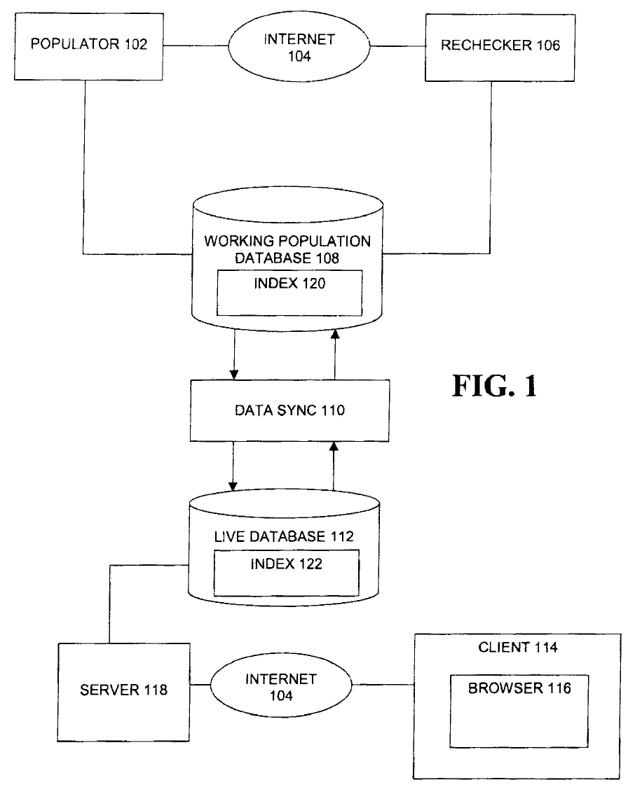

FIG. 1 depicts a block diagram illustrating the system of the present invention. Client 114 allows an Internet user to access sites on the Internet 104. Client 114 is a computer terminal running browser 116. Server 118 is operating a search engine 117. Client 114 can access the search engine running on server 118 by entering an appropriate Universal Resource Locator (URL) into browser 116. The search engine 117 allows the client to enter a search query in a conventional manner. After a search query has been entered by a user, server 118 searches an index 122 on live database 112. Index 122 is an index of content found over a networked database, and may be an index of Internet web pages and web sites. Index 122 may also index other Internet resources such as Usenet discussions and FTP sites. Index 122 may also index private Internet, Intranet, or closed network resources.

An implementation includes two different indexes stored on two different databases. Index 120 is stored on working population database 108. Index 122 is stored on live database 112. Index 120 is constantly being updated with new material by populator 102. Populator 102 goes out through the Internet and pulls content such as web pages and indexes them. Periodically, index 122 is updated to match the contents of index 120 via data synch 110.

Two or more matching databases and two or more matching indexes can be used is to increase the speed of searching operation for the search engine users. If index 122 on live database 112 was constantly being updated by populator 102, then the search engine would be very slow because the searches could not be processed at the same time index 122 was being updated. By providing two or more databases 108 and 112, the live database 112 will remain static for periods of time while searches are being conducted rapidly. Periodically, the contents of index 122 are updated to reflect the newly updated portions of index 120. This allows the populator 102 to continually update the index without appreciably slowing down the search engine operations.

Populator 102 traverses or crawls through the Internet 104, pulling Internet resources such as web pages and web sites, and building and updating index 120. Populator 102 traverses the Internet by following links and retrieving web pages. Populator 102 is a type of program called a WebCrawler or a spider. A WebCrawler crawls through the pages of the Internet by following all the links in each page until all the pages have been read. A WebCrawler can visit many sites in parallel at the same tine.

Populator 102 can receive an error message after accessing a link, or can follow a dead link. For example, when the populator tries to access a particular link, it may receive an error message that the server on the other end is not responding, or that no server is located at the specified domain name. If an error message is received, populator 102 can come back later and try again. It is possible that the requested server is just temporarily down. If the populator 102 tries to access the same link a predetermined number of times and receives an error message more than once, or a significant number of times, then the populator 102 can remove the listing of that link from index 120.

Another problem that sometimes occurs is when a server has moved to a new IP address, but retains the same domain name. The local DNS (domain name server) cache might not contain an updated IP address corresponding to the server's domain name. To avoid this problem, populator 102 can access other DNS's at geographically remote locations to determine if they have an updated listing for the IP address of the sought after link.

Rechecker 106 goes through web sites listed in index 120 and checks those sites to see if they have been updated, or if the links are still valid. If rechecker 106 finds a web link that has not been updated or is no longer valid, it flags the link. Populator 102 then rechecks these links at some later time and updates index 120 accordingly.

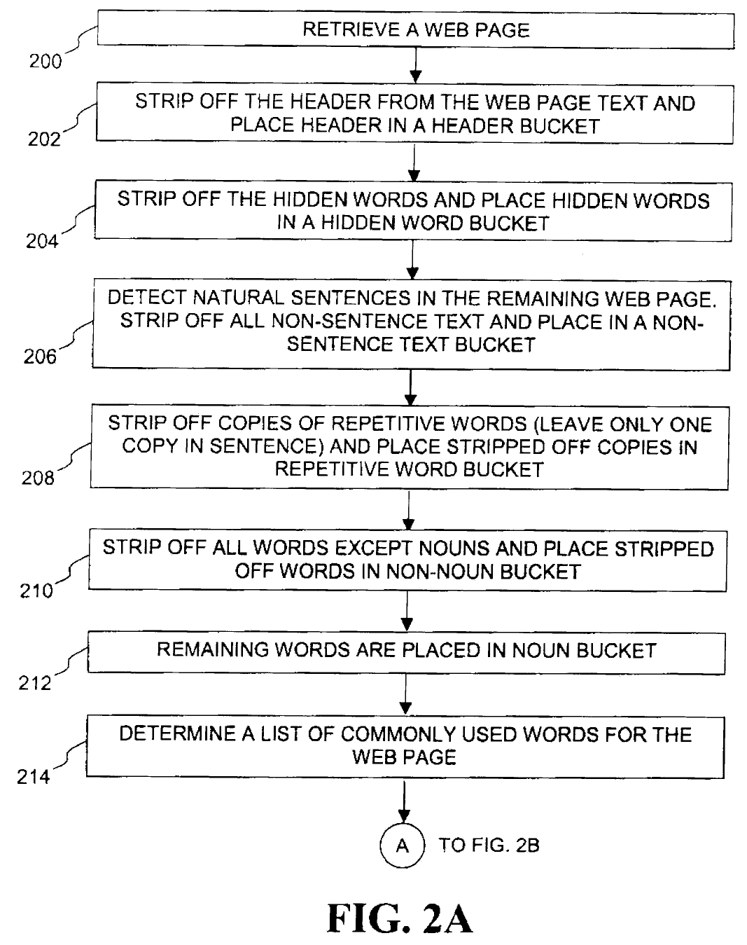

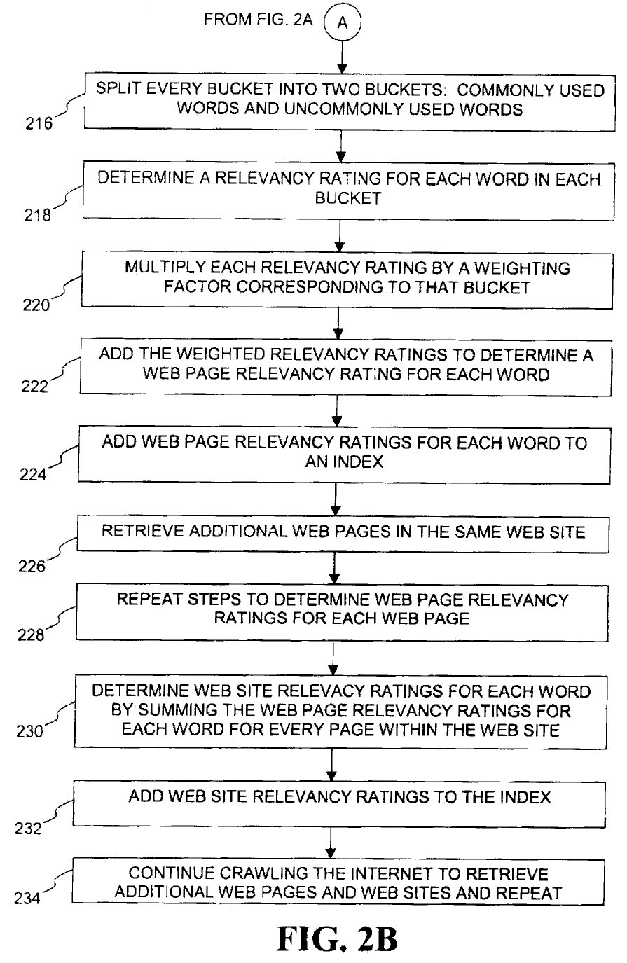

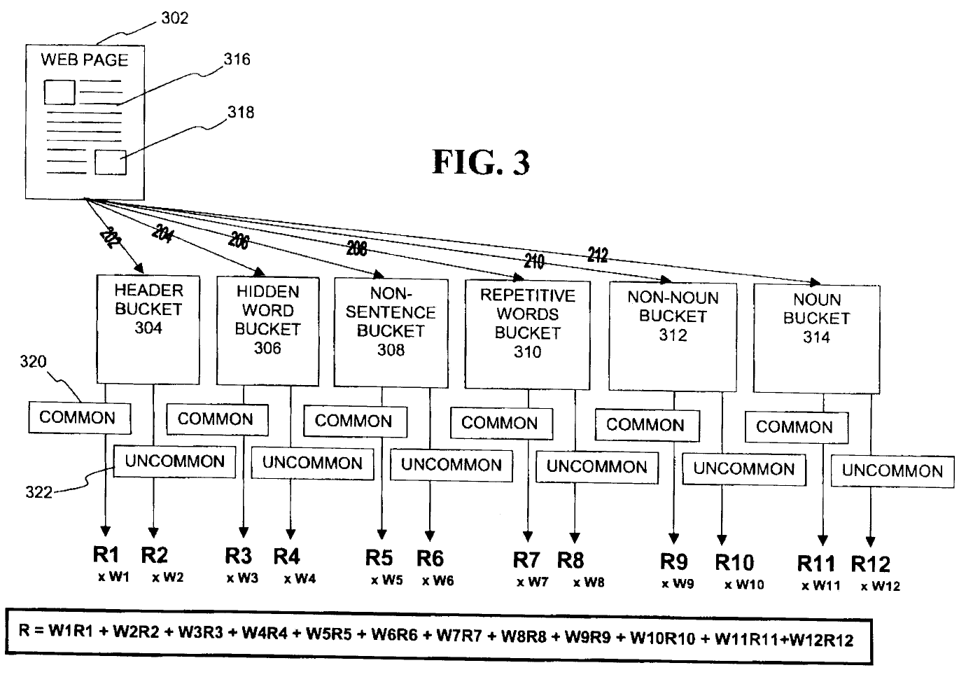

FIGS. 2A and 2B depict a flowchart that illustrates a method for determining relevancy ratings for words in web pages, web sites, and resources on the Internet. FIG. 3 is a block diagram which graphically illustrates how a web page is divided into categories according to the method illustrated in the flowchart of FIGS. 2A and 2B.

In step 200, populator 102 retrieves a web page 302 as shown in FIG. 3. Web page 302 contains various forms of content comprising images 318 and text 316. In step 202, the header text is stripped from the web page and placed in a header bucket 304. The word bucket herein is used to conceptually indicate a storage location where a group of words are temporarily stored. After the header has been stripped off, the remaining text of the web page is referred to as the body of the web page. In step 204, the hidden words are stripped off the remainder of the webpage and placed in a hidden word bucket 306. Hidden words are words that are located in the web page but are not visible to the Internet user. Hidden words can be detected by populator 102 by looking for words having the same font color as the background.

After the hidden words have been stripped off and placed in hidden word bucket 306, web page 302 is left with the text minus the header and the hidden words. In step 206, natural sentences are then detected. A natural sentence can be detected, for example, by looking for a period which signals the end of a sentence. Words in the sentence can be scanned to the left to find the next period to determine the end of the previous sentence. Any words which are not part of a sentence are then stripped off and placed in a non-sentence bucket 308. Other methods of detecting natural sentences may be used as well.

In step 208, repetitive words within sentences are detected and stripped off into repetitive words bucket 310. For example, if the same word is repeated more than once in a row, then all but one of the copies of the word are stripped off and placed in repetitive words bucket 310. Alternatively, if the same word is used more than n times within a single sentence, it can be stripped off and placed in repetitive words bucket 310.

In step 210, all words which are not nouns are stripped off and placed in non-noun bucket 312. For example, verbs, adjectives, and prepositions are all paced in non-noun bucket 312. After all of these steps, the words remaining in web page 302 will all be non-hidden, non-repetitive, non-header nouns found within sentences. In step 212, these remaining nouns are placed in noun bucket 314.

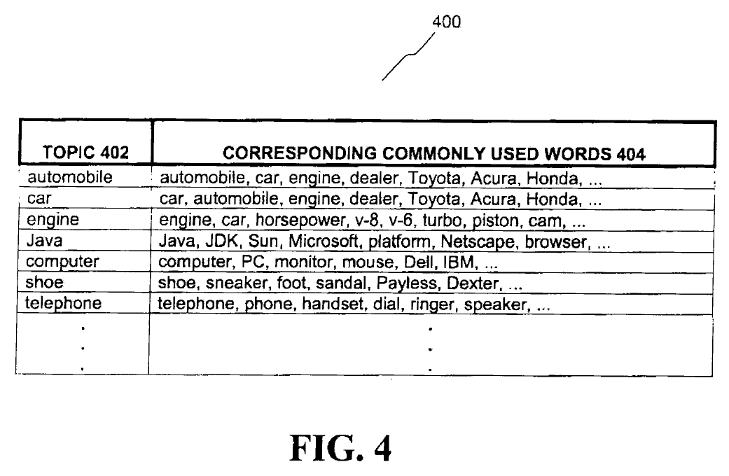

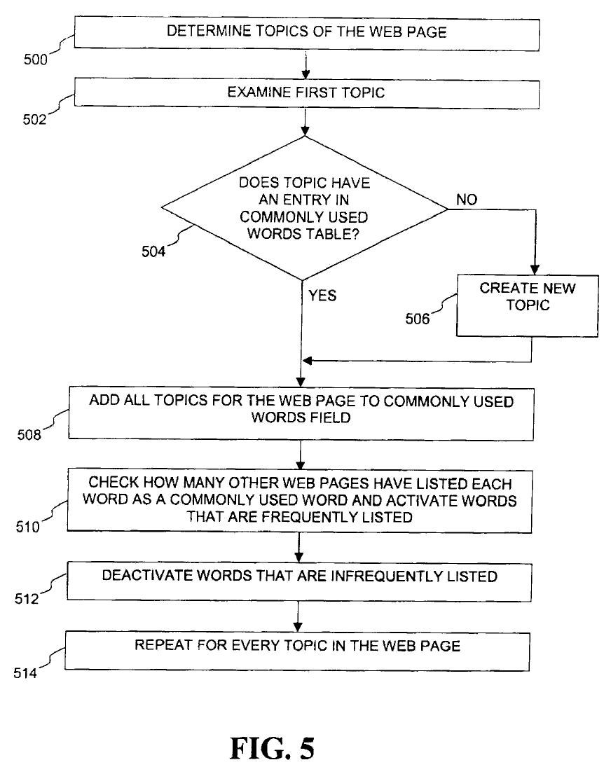

In step 214, a list of commonly used words corresponding to web page 302 is determined. This is done by accessing a table of commonly used words 400 shown in FIG. 4. The manner in which the list of commonly used words is obtained is described in more detail later with respect to FIGS. 4 and 5. In step 216, each bucket is further subdivided into a common bucket 320 and an uncommon bucket 322. In this manner, all of the words in a bucket which are on the list of commonly used words are placed in the common bucket 320, and the other words are placed in uncommon bucket 322. In an implementation, all of the words from the text of web page 302 are divided into, for example, 12 buckets: 6 common buckets, and 6 uncommon buckets.

In step 218, a relevancy rating is determined for each word in each bucket. The relevancy rating is a measure of how many times the word appears in the bucket. For example, if the word “Java” appears seven times in the common bucket of non-noun bucket 312 then “Java” would be assigned a relevancy rating R9=7 for that bucket. Thus, 12 relevancy ratings R1-R12 can be determined for each word appearing in web page 302. For example, the word “Java” will have twelve relevancy ratings R1 through R12.

In step 220, each relevancy rating is weighted by a weighting factor W which is unique to the particular bucket. For example, R1, the relevancy rating for the first bucket, is multiplied by W1, the weighting factor for the first bucket. Other methods of weighting beside straight multiplication could be used. For example, R1 could be squared then multiplied by W1².

In step 222, the weighted relevancy ratings are summed to determine a web page relevancy rating R for each word. Thus R=R1W1+R2W2+R3W3+R4W4+R5W5+R6W6+R7W7+R8W8+R9W9+R10W10+R11W11+R12W12.

In step 224, the web page relevancy ratings R for each word found on web page 302 are added to index 120. In step 226, populator 102 retrieves another web page in the same web site. In step 228, steps 200 through 224 are repeated for each web page in the web site. A web site is a grouping of multiple web pages. For example, a web site named www.website.com might include many web pages, for example, named www.website.com/page1.htm, www.website.com/page2.htm, www.website.com/page3.htm and so on. Each web page is retrieved individually. Each word on every page is given a relevancy ranking which is added to index 120. After all the pages in a web site have been retrieved and indexed, then in step 230 a web site relevancy ranking for each word is calculated by summing the web page relevancy rankings for each page. For example, suppose the word “Java” has the following web page relevancy rankings on five different web pages within the web site: 73, 100, 200, 50, and 40. Then the word “Java” would have a web site relevancy ranking for this site of the sum: 463.

When an Internet user is using a search engine located at a specific web site, and the Internet user searches for a word, for example the word “Java”, the search engine will produce results listing both web pages and web sites according to their relevancy rankings. The web page and the web site results can be intermixed or displayed separately.

After the web site has been completely indexed, then in step 234, populator 202 continues crawling the Internet to index new pages and sites.

In an implementation, weighting factors W1 through W12 are chosen to produce optimal search results for the searcher looking for desired information. For example, the hidden word bucket contains hidden words which were intended to provide misleading results from search engines. Thus, hidden words can be given a relatively low weight. In the exemplary implementation discussed herein, W3 and W4 can thus be relatively low numbers, or alternatively may be zero.

The repetitive words bucket 310 can also be given a relatively low weighting. Repetitive words are also inserted into web pages to provide misleading or false search results. For example, a web page owner seeking to attract people searching for cars might insert into the web page “cars cars cars cars cars cars cars cars cars cars cars . . . ” These repetitive words are designed to mislead search engine crawlers into giving a web page a relatively high ranking for someone searching for the word “cars.” Because these repetitive words are designed to mislead the search engine crawler, the weightings can be relatively low. Therefore W7 and W8 can be relatively low numbers.

Words in sentences are likely to be more reliable than words not in sentences. Words which are not in sentences can also be inserted into the web page to produce misleading search results. For example, the word “cars” appears in the following sentence: “Electric cars are being developed to reduce pollution.” Because the word “cars” is appearing in a sentence, it is likely to be a reliable occurrence. If the word “cars” does not appear in a sentence it is more likely to be a spurious occurrence inserted to mislead a search engine crawler. Therefore, W5 and W6 can be relatively small numbers.

Meta-keywords in the header are inserted by the web page owner to describe the contents of the web page. In some instances, these meta-keywords may be an accurate and efficient section to search. However, if the web page owner is attempting to mislead the crawler, then the web page owner may insert meta-keywords which are irrelevant to the subject matter of the page. Therefore, in the exemplary implementation provided herein, W1 and W2 should be fairly low numbers so as to be able to accurately determine the subject matter of the page.

Continuing with the exemplary implementation discussed herein, two buckets remain: non-noun bucket 312 and noun bucket 314, which contain the most relevant information for searching the web pages, and therefore can be given the highest weightings. Non-noun bucket 312 and noun bucket 314 contain the text of the web page stripped of all potentially erroneous material. Because users are generally searching for objects and nouns rather than actions of adjectives, the noun bucket 314 can receive a higher weighting than the non-noun bucket 312.

For each bucket, the common buckets can be weighted differently than the non-common buckets. By giving a higher weighting to a common bucket over its corresponding uncommon bucket, the search engine can better find distinctive words. For example, suppose a user remembers reading a book once about a rabbit who liked to use computers. The user is likely trying to find the title of the book and some more information about the book. Since the word “rabbit” is not going to be a commonly used word for a web page concerning computers, and vice versa, the word “rabbit” and “computer” will fall into an uncommon bucket. By giving uncommon words a higher relevancy rating, the search engine will do a better job of finding distinctive information.

Different weighting systems can be used to provide the optimal search performance. In an exemplary implementation, multiple weighting systems can be used to generate multiple relevancy ratings for each word which are all stored in the index. For example, in an implementation, populator 102 first uses a set A of weightings W1_{A} through W12_{A}. These weightings give a very low weighting to header bucket 304. A web page relevancy ranking R_{A} is determined for each word in the web page. Next, populator 102 uses a set B of weightings W1_{B} through W12_{B}. These weightings give a higher weighting to header bucket 304. A web page relevancy ranking R_{B} is determined for each word in the web page. Both of these relevancy rankings are then stored in index 120.

In another implementation, the Internet user can be given options as to which weighting system to use. For example, the user can search using weighting system A or the Internet user can search using weighting system B as described above. Weighting system B places more value on the header. Weighting system A does not trust what the web page owners have inserted into the header, thus places lower value on the header. With weighting system A, the results will be ranked using relevancy ratings R_{A} stored in Index 122. With weighting system B, the results will be ranked using relevancy ratings R_{B} stored in index 122.

FIG. 4 displays an example of commonly used words table 400. Commonly used words table 400 includes a topic field 402 and a corresponding commonly used words field 404. As described previously, the commonly used words table is used for generating a list of commonly used words for each web page, which is then used to break up the text of a web page into common buckets and uncommon buckets (Steps 214 and 216 in FIGS. 2A and 2B). A list of commonly used words is generated for each individual web page that is retrieved.

Each list of commonly used words is generated first by determining the topics of a particular web page. Each topic is one word in length. Populator 102 determines the topics of a web page by looking for any word in noun bucket 314 which appears more than n times, where n is a predetermined number. Alternatively, populator 102 can look for words in any bucket that appear more than n times. Alternatively, populator 102 can use meta-keywords as topics.

Once the topics of a web page have been determined, each of these topics is then looked up in topic field 402 in table 400 shown in FIG. 4. The corresponding commonly used words field 404 will then provide a list of commonly used words for each topic. A commonly used words list is generated for a web page by looking up all the commonly used words for all the topics in that web page. For example, in an implementation, populator 102 determines that a web page has two topics: computer and Java, then populator 102 accesses table 400 to generate a list of commonly used words for the web page: Java, JDK, Sun, Microsoft, platform, Netscape, browser, computer, PC, monitor, mouse, Dell, and IBM. This list of commonly used words is then used to break up the buckets into common buckets and uncommon buckets (Step 216 in FIG. 2B).

FIG. 5 depicts a flowchart of an implementation illustrating a method of generating commonly used words table 400. Commonly used words table 400 may be a static table with the entries of commonly used words never changing. Alternatively, commonly used words table 400 can be a living table that is constantly updated by populator 102 as it searches the web and builds index 120. In yet another implementation, commonly used word table 400 can be imported from an third party or can be populated manually by the user.

In step 500, the topics of a web page retrieved by populator 102 are determined. Each topic is one word long. Various methods of determining the topics may be used, as discussed previously. In step 502, the first topic of the web page is examined. In step 504, populator 102 determines if the topic already has an entry in commonly used words table 400. If not, then in step 506, a new entry is created in table 400. For example, if table 400 did not contain an entry for the topic “Java,” then a new row is added to table 400 having the topic “Java.”

In step 508, all the topics for the web page are added to the corresponding commonly used words field 404 in table 400, including the very topic word itself. If that topic word is already listed, then its frequency data is updated (frequency data is described below). For example, suppose that populator 102 determines that a web page 302 has the following topics: Java, JDK, Sun, Microsoft, platform, Netscape, and browser. The first topic in this list is Java. If Java is not yet listed as a topic in table 400, then a new entry is created in table 400, with Java entered in the topic field 402. Next, all the topics for web page 302 are added to the corresponding commonly used words field 404 including the topic word “Java” itself. Thus, the corresponding commonly used words field 404 for the “Java” topic entry would have the following corresponding commonly used words: “Java”, “JDK”, “Sun”, “Microsoft”, “platform”, “Netscape”, and “browser.”

Table 400 can also contain frequency data (not shown) for each word in corresponding commonly used words field 404. The frequency data indicates the frequency with which each word is listed or relisted in commonly used words field 404. For example, populator 102 retrieves a web page which has the topics “Java” and “browser.” If “browser” is already listed in the corresponding commonly used words field 404 for the “Java” topic as shown in FIG. 4, populator 102 will then update the frequency data for the word “browser.” The frequency data indicates that for the last x web pages examined, y pages listed the word “browser” as a commonly used word for the topic “Java.”

After the topics for the web page have been added to corresponding commonly used words field 404 in step 508, populator 102 checks the frequency data for the web page topics. If the frequency for a given word is above a predetermined threshold, then the word is activated by flagging it. Only activated words will be considered as commonly used words when splitting buckets into common and uncommon buckets (steps 214 and 216 in FIGS. 2A and 2B).

In this manner, a number of web pages have to list a word as a commonly used word before the words gets activated in table 400. For example, a web page having an unusual story about a rabbit using a telephone may list the word “rabbit” 40 times and the word “telephone” 40 times. “Telephone” could initially be listed as commonly used word corresponding to the topic “rabbit”, and vice versa. In an implementation, these words will not initially be activated. Since this is an unusual web page, it is unlikely that other web pages will list the word “rabbit” as a commonly used word for the topic “telephone.” Therefore, the word “rabbit” is unlikely to be activated for the topic “telephone.” Similarly the word “telephone” is unlikely to be activated for the topic “rabbit.” If, however, 15 other web pages used the word “telephone” 40 times and the word “rabbit” 40 times, then the word “rabbit” would get activated for the topic “telephone” and vice versa. The numbers 15 and 40 are used by the way of example only.

In step 512, words that were previously activated in table 400 can be deactivated through infrequent listing. For example, should the word “Sun” be activated for the topic “Java,” but in the next 100,000 web pages retrieved by populator 102, the word “Sun” is never listed as a commonly used word for the topic “Java,” populator 102 can deactivate the word “Sun” for infrequent listing.

As mentioned previously, table 400 stores frequency data for each word in corresponding commonly used words field 404. The frequency data is a measure of how often a word is listed by web pages as a commonly used word. Table 400 can optionally store frequency data for each web site. A web site consists of multiple web pages. For example, the web site frequency data could indicate that 50 out of the last 100,000 web sites listed the word “Java” as a commonly used word for the topic “Sun.” Populator 102 could also impose a requirement that a particular word appear a predetermined number of times in a given web site, rather than a web page, before it is listed as a commonly used word in table 400. Populator 102 could also optionally impose a requirement that there be both a web site and a web page requirement. For example, the word “Java” must appear 10 times on a web page and 40 times on a web site before it is listed as a commonly used word.

In this manner, commonly used words table 400 becomes a living table. As populator 102 retrieves a web page and builds index 120, it also continually builds and updates commonly used words table 400. New commonly used words are added and activated by frequent listing. Activated commonly used words can be deactivated through infrequent listing.

Although the present invention has been described in terms of various embodiments, it is not intended that the invention be limited to these embodiments. Modification within the spirit of the invention will be apparent to those skilled in the art. The scope of the present invention is defined by the claims that follow.

1. A method for building an index of Internet web pages, comprising of:
retrieving a web page;
dividing words within the web page into a plurality of categories;
determining a relevancy rating for at least one word in each category, the relevancy rating based on the number of appearances of the word in the corresponding category;
weighting each relevancy rating by a weighting factor corresponding to the category;
summing the weighted relevancy ratings to determine a web page relevancy rating for each unique word.

2. The method of claim 1 wherein the categories comprise: a header; hidden words; non-sentences; repetitive words; non-nouns; and nouns.

3. The method of claim 1, further comprising:
subdividing each of the plurality of categories into subcategories of commonly used words and uncommonly used words.

4. The method of claim 3, wherein a relevancy rating is determined for each subcategory.

5. The method of claim 4, wherein each subcategory comprises a corresponding weighting factor.

6. The method of claim 1, further comprising:
determining a web page relevancy rating for each web page associated with a web site
summing the web page relevancy ratings for each word to determine a web site relevancy rating.

7. The method of claim 1, further including:
building an index having a plurality of records, each record comprising; a word; web pages on which the word appears; and the web page relevancy ranking for the word for each web page.

8. The method of claim 7, wherein the index further comprises:
web sites on which the word appears; and
a web site relevancy rating for each web site.

9. The method of claim 1, wherein the categories are formed by:
removing the header from the web page to form the header category;
removing the hidden words from the remainder of the web page to form the hidden words category;
removing words not in sentences from the remainder of the web page to form the non-sentence words category;
removing repetitive words within sentences from the remainder of the web page to form the repetitive words category;
removing non-nouns from the remainder of the page to form the non-nouns category; and
removing nouns from the remainder of the page to form the nouns category.

10. The method of claim 3, wherein the commonly used words are determined by generating a list of commonly used words for each web page.

11. The method of claim 10, wherein the list of commonly used words is generated by referencing a commonly used words table.

12. The method of claim 11, wherein the commonly used words table is continually updated.

13. A method for assigning a relevancy rating to words within an Internet web page, comprising:
retrieving a web page from the Internet;
determining a first relevancy rating for a first word in the web page, the relevancy rating based on the number of appearances of the first word in one or more categories, the categories comprising: a header; hidden words; non-sentences; repetitive words; non-nouns; and nouns;
determining a second relevancy rating for the word, the second relevancy rating based on the number of appearances of that word in different category than used for the first relevancy rating;
weighting the first relevancy rating by a first weighting factor;
summing the weighted first and second relevancy ratings to determine a final relevancy rating.

14. A method for indexing a web page, comprising:
retrieving a web page;
determining a relevancy rating for a word in the web page based on the number of occurrences of the word; wherein the relevancy rating for the word is weighted such that words designed to fool search engines are weighted lower than other words.

15. Computer executable software code stored on a computer readable medium, performing a method of:
retrieving a web page;
dividing words within the web page into a plurality of categories;
determining a relevancy rating for at least one word in each category, the relevancy rating based on the number of appearances of the word in the corresponding category;
weighting each relevancy rating by a weighting factor corresponding to the category;
summing the weighted relevancy ratings to determine a web page relevancy for each unique word.

16. Computer executable software code performing the method of:
retrieving a web page;
dividing words within the web page into a plurality of categories;
determining a relevancy rating for at least one word in each category, the relevancy rating based on the number of appearances of the word in the corresponding category;
weighting each relevancy rating by a weighting factor corresponding to the category;
summing the weighted relevancy ratings to determine a web page relevancy rating for each unique word.
